(19) United States
(12) Patent Application Publication
(10) Pub. No.: US 2019/0025604 A1
(43) Pub. Date: Jan. 24, 2019

(54) SPACE DISPLAY APPARATUS

(71) Applicant: PANASONIC INTELLECTUAL PROPERTY MANAGEMENT CO., LTD., Osaka (JP)

(72) Inventor: Masaomi SHIBATA, Hyogo (JP)

(73) Assignee: PANASONIC INTELLECTUAL PROPERTY MANAGEMENT CO., LTD., Osaka (JP)

(21) Appl. No.: 16/067,736

(22) PCT Filed: Feb. 15, 2017
(86) PCT No.: PCT/JP2017/005502

§ 371 Date: Jul. 2, 2018

(30) Foreign Application Priority Data
Feb. 19, 2016 (JP) 2016-030496

(51) Int. Cl. G02B 27/22; G06F 3/0346; H04N 13/305; G02B 5/12

(52) U.S. Cl. CPC G02B 27/2292; G02B 5/12; H04N 13/305; G06F 3/0346

(57) ABSTRACT

A space display apparatus that forms an image in an aerial display region and displays the image as an aerial image, includes: a display that displays the image on a display surface; a concave lens; and an imaging optical element that includes an element surface, is located between the display surface and the concave lens, and, in the case of assuming that the concave lens is not present, forms the image displayed on the display surface, in a provisional region that is plane-symmetrical to the display surface with respect to the element surface, wherein the concave lens is located at a position where a distance from the concave lens to the provisional region is shorter than a focal length of the concave lens.

### TECHNICAL FIELD

The present invention relates to a space display apparatus that displays an aerial image in an aerial display region.

### BACKGROUND ART

Technology for enabling viewing of aerial images has been developed in recent years. For example, PTL 1 discloses an optical system including a reflective plane-symmetrical imaging element.

### CITATION LIST

### Patent Literature

PTL 1: Japanese Unexamined Patent Application Publication No. 2008-158114

### SUMMARY OF THE INVENTION

### Technical Problem

The conventional reflective plane-symmetrical imaging element forms an image displayed on a display, at a position plane-symmetrical to the display with respect to the element surface as an aerial image. In other words, the size of the aerial image and its distance from the element surface are equal to the size of the image displayed on the display and its distance from the element surface. Accordingly, to enlarge the aerial image displayed, the display and the reflective plane-symmetrical imaging element are increased in size. Moreover, to display the aerial image at a position away from the reflective plane-symmetrical imaging element, the distance between the display and the reflective plane-symmetrical imaging element is increased. This causes an increase in optical system size.

The present invention therefore has an object of providing a compact space display apparatus capable of enlarged display or remote display.

### Solution to Problem

To achieve the stated object, a space display apparatus according to an aspect of the present invention is a space display apparatus that forms an image in an aerial display region and displays the image as an aerial image, the space display apparatus including: an image display that displays the image on a display surface; a concave lens; and an imaging optical element that includes an element surface, is located between the display surface and the concave lens, and, in the case of assuming that the concave lens is not present, forms the image displayed on the display surface, in a provisional region that is plane-symmetrical to the display surface with respect to the element surface, wherein the concave lens is located at a position where a distance from the concave lens to the provisional region is shorter than a focal length of the concave lens.

### Advantageous Effect of Invention

According to the present invention, a compact space display apparatus capable of enlarged display or remote display can be provided.

### BRIEF DESCRIPTION OF DRAWINGS

FIG. 1 is a perspective diagram illustrating an example of applying a space display apparatus according to an embodiment to a kitchen.

FIG. 2A is a sectional diagram illustrating an example of applying the space display apparatus according to the embodiment to a kitchen.

FIG. 2B is a sectional diagram illustrating another example of applying the space display apparatus according to the embodiment to a kitchen.

FIG. 3 is a sectional diagram illustrating an example of applying the space display apparatus according to the embodiment to a modular bath.

FIG. 4 is a schematic diagram illustrating aerial image display principle in the case of assuming that a concave lens is not included in the space display apparatus according to the embodiment.

FIG. 5 is a general perspective diagram of the space display apparatus according to the embodiment.

FIG. 6 is a schematic sectional diagram illustrating the structure of the space display apparatus according to the embodiment.

FIG. 7 is a schematic diagram illustrating the principle of the space display apparatus according to the embodiment.

FIG. 8 is a diagram illustrating a property table associating users and adjustment modes according to the embodiment.

FIG. 9 is a diagram illustrating an action table associating user actions and adjustment modes according to the embodiment.

FIG. 10 is a diagram illustrating the relationship of the aerial image display magnification and display position with the distance between a concave lens and a provisional region according to the embodiment.

FIG. 11 is a schematic diagram illustrating a change of an aerial image in the case of moving a display in the space display apparatus according to the embodiment.

FIG. 12 is a schematic diagram illustrating a change of an aerial image in the case of moving an imaging optical element in the space display apparatus according to the embodiment.

FIG. 13 is a schematic diagram illustrating a change of an aerial image in the case of moving a concave lens in the space display apparatus according to the embodiment.

### DESCRIPTION OF EXEMPLARY EMBODIMENT

The following describes a space display apparatus according to an embodiment of the present invention in detail, with reference to drawings.

The embodiment described below shows a specific example of the present invention. The numerical values, shapes, materials, structural elements, the arrangement and connection of the structural elements, steps, the order of steps, etc. shown in the following embodiment are mere examples, and do not limit the scope of the present invention. Of the structural elements in the embodiment described below, the structural elements not recited in any one of the independent claims representing the broadest concepts of the present invention are described as optional structural elements.

Each drawing is a schematic and does not necessarily provide precise depiction. The scale, etc. in the drawings are therefore not necessarily consistent. The substantially same structural elements are given the same reference marks throughout the drawings, and repeated description is omitted or simplified.

### Embodiment

### Overview

An overview of a space display apparatus according to this embodiment is given below.

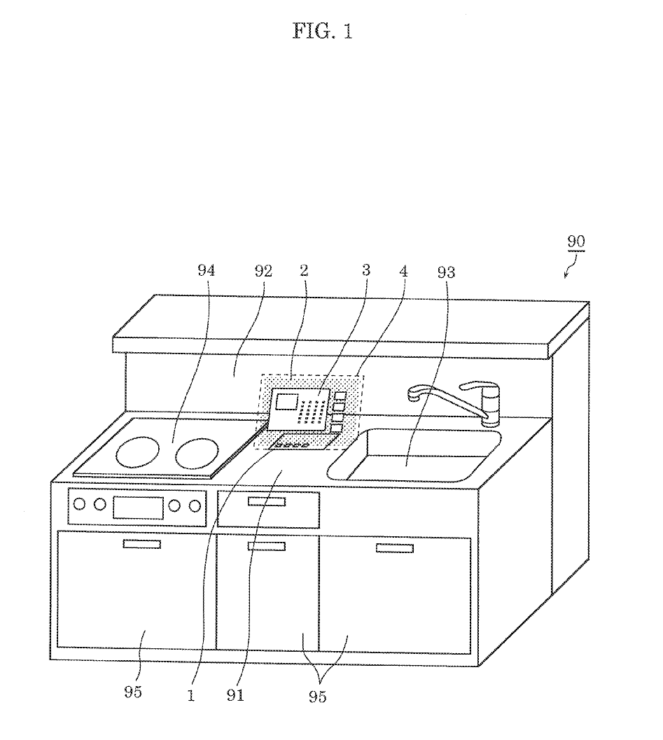

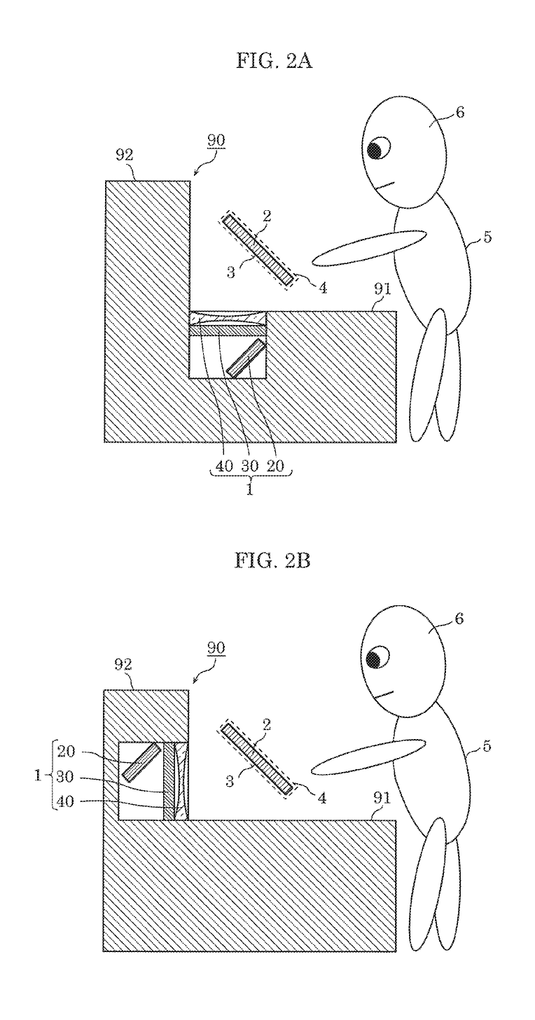

FIG. 1 is a perspective diagram illustrating an example of applying space display apparatus 1 according to this embodiment to kitchen 90. FIGS. 2A and 2B are each a sectional diagram illustrating an example of applying space display apparatus 1 according to this embodiment to kitchen 90.

Space display apparatus 1 is incorporated in kitchen counter 91, as illustrated in FIGS. 1 and 2A. Alternatively, space display apparatus 1 may be incorporated in kitchen wall 92, as illustrated in FIG. 2B. Display region 3 is a space region located above kitchen counter 91 or in front of kitchen wall 92. Thus, user 5 standing in front of kitchen counter 91 or kitchen wall 92 can easily view aerial image 2.

Kitchen 90 is, for example, a facility used by user 5 for cooking and dishwashing. In detail, kitchen 90 is a fitted kitchen, and includes: kitchen counter 91 for performing tasks such as cooking; partition-like kitchen wall 92 at the back of kitchen counter 91; sink 93 incorporated in kitchen counter 91; cooking heater 94 provided along with kitchen counter 91; and cabinets 95 installed below kitchen counter 91. In this embodiment, space display apparatus 1 is incorporated in kitchen counter 91.

Space display apparatus 1 forms an image in aerial display region 3 and displays it as aerial image 2, as illustrated in FIG. 1, 2A, or 2B. For example, space display apparatus 1 displays aerial image 2 of a cooking recipe or the like in display region 3. This allows user 5 to cook while viewing a recipe or the like displayed as aerial image 2.

Aerial image 2 displayed in display region 3 is operable by user 5 (described in more detail later). That is, user operation region 4 is set according to the position of display region 3. User operation region 4 approximately matches display region 3, and is a region for, in the case where user 5 performs an operation so as to touch aerial image 2, detecting the operation. For example, aerial image 2 is changed to another image by a user operation.

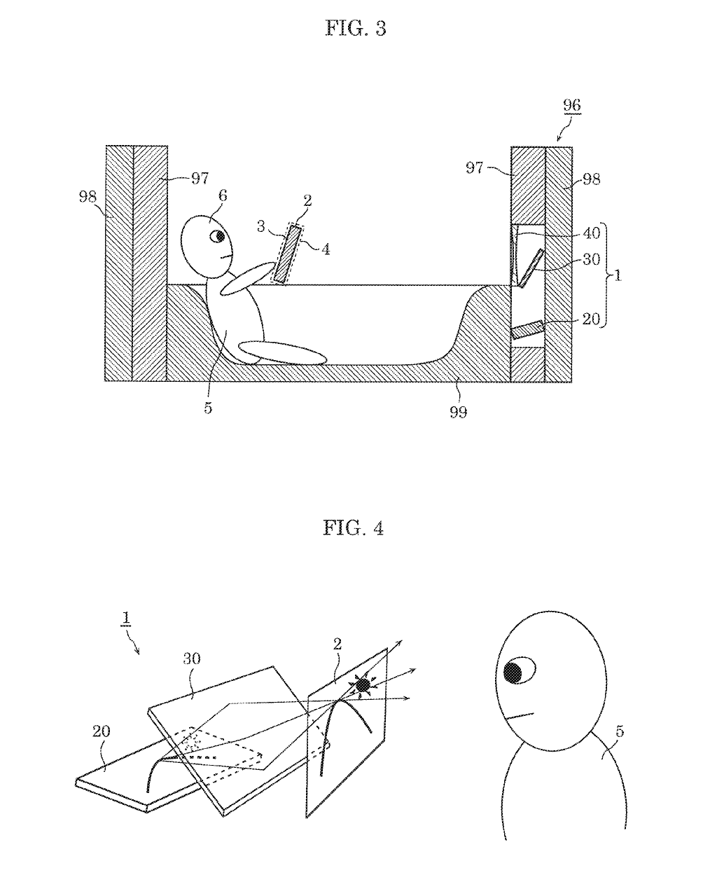

Space display apparatus 1 may be applied to modular bath 96 instead of kitchen 90, as illustrated in FIG. 3. FIG. 3 is a schematic diagram illustrating an example of applying space display apparatus 1 according to this embodiment to modular bath 96.

As illustrated in FIG. 3, space display apparatus 1 may be incorporated in bath wall 97 of modular bath 96. Bath wall 97 is fixed to the inner side of outer wall 98. Display region 3 is located above bathtub 99. This allows user 5 to view aerial image 2 in bathtub 99.

Space display apparatus 1 includes display 20, imaging optical element 30, and concave lens 40, as illustrated in FIG. 2A, 2B, or 3. Space display apparatus 1 displays an image displayed by display 20 on its display surface, as aerial image 2 by imaging optical element 30 and concave lens 40.

In this embodiment, space display apparatus 1 includes concave lens 40, to enable enlarged display or remote display of the image displayed by display 20. The principle of displaying aerial image 2 in the case of assuming that space display apparatus 1 does not include concave lens 40 is briefly described below, with reference to FIG. 4. FIG. 4 is a schematic diagram illustrating the principle of displaying aerial image 2 in the case of assuming that concave lens 40 is not included in space display apparatus 1 according to this embodiment.

As illustrated in FIG. 4, space display apparatus 1 displays a two-dimensional image displayed on display 20, three-dimensionally and aerially as aerial image 2. In other words, space display apparatus 1 can display an image (aerial image 2) in a state of floating in air. Here, display region 3 in which aerial image 2 is displayed is plane-symmetrical to the display surface of display 20 with respect to the element surface of imaging optical element 30. The size and position of aerial image 2 are equal to the size and position of the display surface.

In this embodiment, the image (video) displayed on the display surface of display 20 may be any of a still image and a moving image. Examples include content video stored in space display apparatus 1, broadcasted video or recorded video of a television program, reproduced video of a BD (Blu-ray® Disc) or a DVD (Digital Versatile Disc), and an Internet image.

### [Structure]

The structure of space display apparatus 1 is described in detail below.

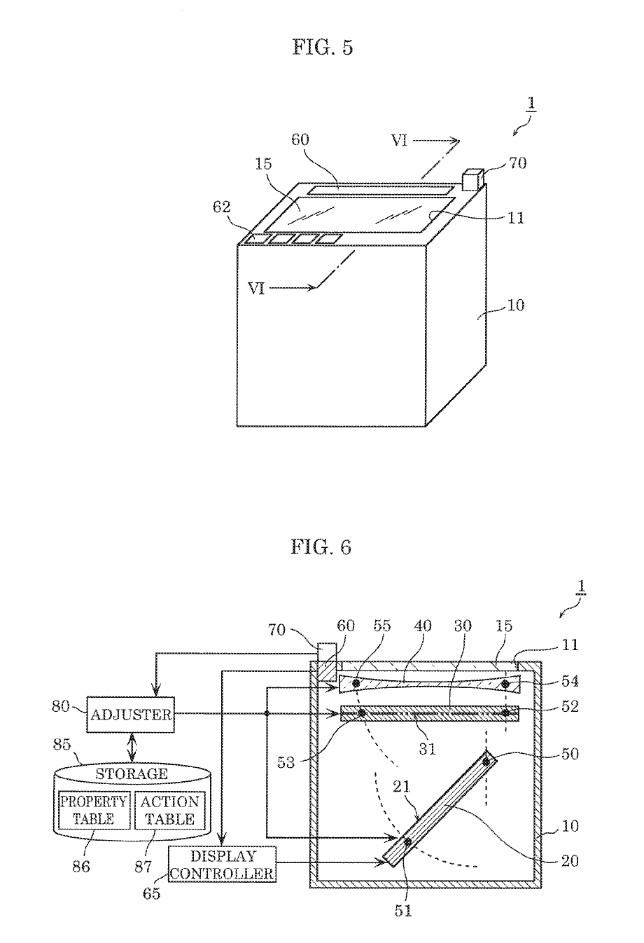

FIG. 5 is a general perspective diagram of space display apparatus 1 according to this embodiment. FIG. 6 is a schematic sectional diagram illustrating the structure of space display apparatus 1 according to this embodiment. In detail, FIG. 6 schematically illustrates a section along VI-VI line in FIG. 5.

Space display apparatus 1 includes housing 10, motion sensor 60, one or more switches 62, and camera 70, as illustrated in FIG. 5. Inside housing 10, space display apparatus 1 includes display 20, imaging optical element 30, concave lens 40, display surface drives 50 and 51, element drives 52 and 53, and lens drives 54 and 55, as illustrated in FIG. 6.

Space display apparatus 1 also includes display controller 65, adjuster 80, and storage 85. Display controller 65, adjuster 80, and storage 85 are implemented by control circuitry such as a system LSI (Large Scale Integration) or a microcomputer. The control circuitry is, for example, attached to the inside or outside of housing 10.

Space display apparatus 1 is thus unitized, with each structural member being contained inside housing 10 or fixed to the outside. This eases the operation of installing space display apparatus 1. Moreover, since installation personnel do not need to directly touch the optical system such as display 20, imaging optical element 30, and concave lens 40 with bare hands or the like, the adhesion of dirt such as foreign matter or fingerprints can be prevented. Hence, aerial image 2 can be kept from being blurred due to dirt.

### [Housing]

Housing 10 is an outer housing of space display apparatus 1. As illustrated in FIG. 6, display 20, imaging optical element 30, concave lens 40, display surface drives 50 and 51, element drives 52 and 53, and lens drives 54 and 55 are contained inside housing 10. Motion sensor 60 and one or more switches 62 are embedded in the outer wall of housing 10, as illustrated in FIGS. 5 and 6. In addition, camera 70 is attached to the outer surface of housing 10. The positions of motion sensor 60 and camera 70 and the method of fixing them to housing 10 are not limited. For example, motion sensor 60 and camera 70 may be contained inside housing 10. Motion sensor 60 and camera 70 may, for example, detect a finger and face 6 of user 5 outside housing 10, through cover glass 15.

In this embodiment, the outer shape of housing 10 is approximately a rectangular parallelepiped. Alternatively, the outer shape of housing 10 may be approximately a circular cylinder. The outer shape of housing 10 is not limited to such. For example, housing 10 is made of a metal material such as aluminum, or a resin material.

Housing 10 has opening 11 for extracting light from display 20 to the outside, in its surface facing concave lens 40. Cover glass 15 is provided in opening 11, as illustrated in FIG. 5. Cover glass 15 is a translucent glass plate that allows visible light to pass through. For example, cover glass 15 is made of transparent soda glass. Cover glass 15 covers opening 11, thus preventing the entry of foreign matter and the like into housing 10.

The size of housing 10 is not limited, but the width or depth is 10 cm or less as an example. Such housing 10 (space display apparatus 1) can be embedded in bath wall 97 of typical modular bath 96 or the like, as illustrated in FIG. 3.

### [Display (Image Display)]

Display 20 is an example of an image display that displays an image on display surface 21. Display 20 has display surface 21 on the imaging optical element 30 side, as illustrated in FIG. 6. Display 20 is, for example, a liquid crystal display (LCD) or an organic electroluminescence (EL) display device. On display surface 21, for example, a plurality of pixels are arranged in a matrix. For example, an image of 1 frame is displayed on display surface 21.

In this embodiment, the position and posture of display surface 21 are adjustable. FIG. 6 indicates the range of movement of display surface 21 by dashed lines. As illustrated in FIG. 6, display surface drive 50 is attached to one end of display 20, and display surface drive 51 is attached to the other end of display 20. Display surface drives 50 and 51 move the ends of display 20, to change the position and posture of display surface 21.

### [Imaging Optical Element]

Imaging optical element 30 is a reflective plane-symmetrical imaging element. Imaging optical element 30 is, for example, a flat plate made of a resin material. Imaging optical element 30 has element surface 31. As indicated by a dashed-two dotted line in FIG. 6, element surface 31 is an imaginary plane extending along the thickness center of imaging optical element 30, and is parallel to a main surface (incident surface or emission surface) of imaging optical element 30.

In detail, element surface 31 has, for example, minute through holes of 100 μm per side and 100 μm in depth, with the inner walls of the through holes forming specular surfaces (micromirrors). Light passing through each through hole is reflected twice by micromirrors of two adjacent surfaces.

With the structure described above, imaging optical element 30 forms a mirror image of the light source, at a position plane-symmetrical to the light source with respect to element surface 31. In other words, the distance from element surface 31 to the light source and the distance from element surface 31 to the mirror image are equal, and the size of the light source and the size of the mirror image are equal.

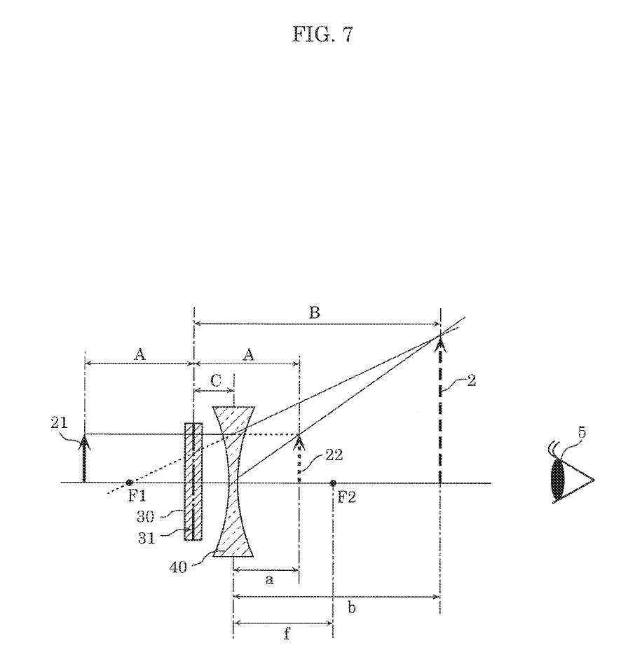

FIG. 7 is a schematic diagram illustrating the principle of space display apparatus 1 according to this embodiment.

In this embodiment, imaging optical element 30 is located between display surface 21 and concave lens 40. As illustrated in FIG. 7, in the case of assuming that concave lens 40 is not present, imaging optical element 30 forms an image displayed on display surface 21, in provisional region 22 which is plane-symmetrical to display surface 21 with respect to element surface 31. The distance from imaging optical element 30 to display surface 21 and the distance from imaging optical element 30 to provisional region 22 are equal. Moreover, the size of the image displayed on display surface 21 and the size of the image (real image) formed in provisional region 22 in the case of assuming that concave lens 40 is not present are equal. Actually, however, concave lens 40 is present, so that the image is not formed in provisional region 22.

For example, the size of imaging optical element 30 is greater than or equal to the size of display surface 21 of display 20. This enables imaging optical element 30 to form the whole image displayed on display surface 21, in provisional region 22.

In this embodiment, the position and posture of imaging optical element 30 are adjustable. FIG. 6 indicates the range of movement of imaging optical element 30 (element surface 31) by dashed lines. As illustrated in FIG. 6, element drive 52 is attached to one end of imaging optical element 30, and element drive 53 is attached to the other end of imaging optical element 30.

Element drives 52 and 53 move the ends of imaging optical element 30, to change the position and posture of element surface 31.

### [Concave Lens]

Concave lens 40 is located on the side of imaging optical element 30 opposite to display 20. In detail, concave lens 40 is located at a position where distance a from concave lens 40 to provisional region 22 is shorter than focal length f of concave lens 40, as illustrated in FIG. 7. Thus, concave lens 40 is located at a position that is between imaging optical element 30 and provisional region 22 and satisfies 0<a<f.

Since the distance between provisional region 22 and concave lens 40 is shorter than focal length f of concave lens 40, the image that could be formed in provisional region 22 by imaging optical element 30 acts as a virtual light source for concave lens 40. Accordingly, concave lens 40 forms aerial image 2 in display region 3 as an erect real image, based on the image that could be formed in provisional region 22.

Resulting aerial image 2 is an enlargement of the image displayed on display surface 21 due to the enlargement function of concave lens 40, as illustrated in FIG. 7. Thus, concave lens 40 can move the position at which the image is formed by imaging optical element 30 from provisional region 22 to display region 3, and also enlarge the image.

In this embodiment, display 20 (display surface 21), focal point F1 of concave lens 40 on the display 20 side, imaging optical element 30, concave lens 40, provisional region 22, and focal point F2 of concave lens 40 on the user 5 side are located in this order. Hence, aerial image 2 is displayed between user 5 and focal point F2. Here, if provisional region 22 is located between concave lens 40 and focal point F2, imaging optical element 30 may be located between focal point F1 and display 20. Alternatively, display 20 may be located between focal point F1 and imaging optical element 30.

Provisional region 22 is plane-symmetrical to display surface 21 with respect to element surface 31, as mentioned above. In other words, the size and position of provisional region 22 are equal to the size and position of display surface 21.

Based on lens formula, −1/a+1/b=−1/f holds. Distance b between concave lens 40 and aerial image 2 is therefore defined by the following (Expression 1).

b=a×f(f−a). (Expression 1)

Display magnification m is represented by the size of aerial image 2 relative to display surface 21 (i.e. provisional region 22). In detail, display magnification m is expressed as b/a, as can be seen from FIG. 7. Based on (Expression 1), display magnification m is defined by the following (Expression 2).

m=b/a=f/(f−a). (Expression 2)

For example, suppose focal length f of concave lens 40 is 60 mm. In such a case, when distance a between concave lens 40 and provisional region 22 is 40 mm, display magnification m is 3 times, and distance b is 120 mm, based on (Expression 1) and (Expression 2).

Distance a between concave lens 40 and provisional region 22 is expressed by the difference (=A−C) between distance A between imaging optical element 30 and display surface 21 and distance C between imaging optical element 30 and concave lens 40. Moreover, aerial image 2 is displayed at a position away from imaging optical element 30 by distance B (=C+b). For example, by setting distance A to 70 mm and distance C to 30 mm, aerial image 2 is displayed at a position away from imaging optical element 30 by 150 mm.

In this embodiment, the position and posture of concave lens 40 are adjustable. FIG. 6 indicates the range of movement of concave lens 40 by dashed lines. As illustrated in FIG. 6, lens drive 54 is attached to one end of concave lens 40, and lens drive 55 is attached to the other end of concave lens 40. Lens drives 54 and 55 move the ends of concave lens 40, to change the position and posture of concave lens 40.

For example, the size of concave lens 40 is greater than or equal to element surface 31 of imaging optical element 30.

### [Drive]

Display surface drives 50 and 51 change the position and posture of display surface 21 of display 20, based on a control signal from adjuster 80. In detail, display surface drive 50 moves one end of display 20 along the normal direction of cover glass 15, and display surface drive 51 rotates display 20 with display surface drive 50 as a fulcrum, as illustrated in FIG. 6.

In this way, display surface drives 50 and 51 can move display 20 closer to or away from imaging optical element 30, while maintaining the posture of display 20. The posture of display 20 is represented by the angle (inclination) which display surface 21 forms with element surface 31 of imaging optical element 30 (or cover glass 15). Display surface drives 50 and 51 can also change the posture of display 20, while maintaining the position of the end (display surface drive 50) of display 20. Display surface drives 50 and 51 can further change both the position and posture of display 20.

Element drives 52 and 53 change the position and posture of element surface 31 of imaging optical element 30, based on a control signal from adjuster 80. The detailed operations of element drives 52 and 53 are respectively the same as those of display surface drives 50 and 51.

In this way, element drives 52 and 53 can move imaging optical element 30 closer to or away from concave lens 40, while maintaining the posture of imaging optical element 30. The posture of imaging optical element 30 is represented by the angle (inclination) which element surface 31 forms with the center plane of concave lens 40 (or cover glass 15). Element drives 52 and 53 can also change the posture of imaging optical element 30, while maintaining the position of the end (element drive 52) of imaging optical element 30. Element drives 52 and 53 can further change both the position and posture of imaging optical element 30.

Lens drives 54 and 55 change the position and posture of concave lens 40, based on a control signal from adjuster 80. The detailed operations of lens drives 54 and 55 are respectively the same as those of display surface drives 50 and 51.

In this way, lens drives 54 and 55 can move concave lens 40 closer to or away from imaging optical element 30, while maintaining the posture of concave lens 40. The posture of concave lens 40 is represented by the angle (inclination) which the center plane of concave lens 40 forms with element surface 31 of imaging optical element 30 (or cover glass 15). Lens drives 54 and 55 can also change the posture of concave lens 40, while maintaining the position of the end (lens drive 54) of concave lens 40. Lens drives 54 and 55 can further change both the position and posture of concave lens 40.

Display surface drives 50 and 51, element drives 52 and 53, and lens drives 54 and 55 are, for example, motors or actuators.

### [Motion Sensor (Operation Detector)]

Motion sensor 60 is an example of an operation detector that detects an operation of user 5 on aerial image 2 in user operation region 4 set according to the position of display region 3. For example, user operation region 4 is a region including display region 3, as illustrated in FIGS. 1 to 3.

Motion sensor 60 includes, for example, an infrared light emitting diode (LED) and an image sensor. Motion sensor 60 detects an operation of user 5, by receiving, by the image sensor, reflected light generated as a result of infrared light from the infrared LED being reflected by a finger of user 5. Alternatively, motion sensor 60 may be a stereo camera or a time-of-flight (TOF) distance sensor.

In this embodiment, in the case where at least one of the size, position, and posture of display region 3 changes as a result of adjustment by adjuster 80, motion sensor 60 adjusts the size, position, and posture of user operation region 4 according to changed display region 3. In detail, motion sensor 60 changes user operation region 4 so as to follow the change of display region 3.

### [Switch]

Switch 62 is a switch for controlling display controller 65 (or display 20) and adjuster 80. For example, switch 62 is a mechanical switch (e.g. push button), a touch sensor, or a contactless sensor.

In this embodiment, a plurality of switches 62 are provided at the outer surface of housing 10, as illustrated in FIG. 5. For example, the plurality of switches 62 include a power switch for turning on and off display by display 20, and an adjustment switch for adjusting the position or posture of each of display 20, imaging optical element 30, and concave lens 40.

As an example, in the case where user 5 operates adjustment switch 62, switch 62 outputs a control signal to adjuster 80. In response to the control signal, adjuster 80 controls the position or posture of display 20, imaging optical element 30, and concave lens 40. As another example, in the case where user 5 operates power switch 62, switch 62 outputs a control signal to display controller 65 (or display 20). Display controller 65 (or display 20) responsively starts or stops image display on display surface 21.

Thus, with the inclusion of switch 62, space display apparatus 1 can receive an operation from user 5 in the case where, for example, aerial image 2 is not displayed or motion sensor 60 is not working. This enhances user-friendliness.

### [Display Controller]

Display controller 65 controls the display on display surface 21 of display 20. In detail, display controller 65 generates an image, and causes the generated image to be displayed on display surface 21. Display controller 65 generates a still image such as an operation image or a moving image such as video, and causes the generated image to be displayed on display surface 21.

In detail, display controller 65 generates a predetermined image, based on a user operation detected by motion sensor 60 or switch 62. As an example, in the case where motion sensor 60 detects that a graphical user interface (GUI) included in an operation image has been operated by user 5, display controller 65 generates an image (e.g. next operation image) corresponding to the operation on the GUI, and causes the generated image to be displayed on display surface 21. As another example, in the case where motion sensor 60 (or switch 62) detects that a start button for a recipe indicating a cooking procedure or a movie has been pressed, display controller 65 causes the recipe or the movie to be displayed on display surface 21.

Although this embodiment describes the case where display controller 65 is a different structural element from display 20, display controller 65 may be included in display 20.

### [Camera (Detector)]

Camera 70 is an example of a detector that detects user 5. In detail, camera 70 detects face 6 of user 5, or an action of user 5. For example, camera 70 captures an image of user 5 to generate moving image data showing user 5, and outputs the moving image data to adjuster 80. In detail, camera 70 includes a light receiving element such as an image sensor, and an optical element such as a lens.

### [Adjuster]

Adjuster 80 adjusts at least one of the position and posture of at least one of display surface 21, imaging optical element 30, and concave lens 40. In this embodiment, adjuster 80 performs the adjustment according to user 5 detected by camera 70.

In detail, adjuster 80 performs the adjustment based on the position of face 6 of user 5 detected by camera 70. For example, adjuster 80 performs the adjustment so that display region 3 is located at a predetermined first position in the case where the distance between face 6 of user 5 and imaging optical element 30 is greater than a predetermined distance, and performs the adjustment so that display region 3 is located at a second position closer to imaging optical element 30 than the first position in the case where the distance between face 6 of user 5 and imaging optical element 30 is less than the predetermined distance. As an example, adjuster 80 performs the adjustment so that display region 3 is farther from imaging optical element 30 when face 6 is farther from imaging optical element 30, and performs the adjustment so that display region 3 is closer to imaging optical element 30 when face 6 is closer to imaging optical element 30.

In this way, for example, for tall user 5, aerial image 2 is displayed at a position closer to user 5. This enhances user-friendliness.

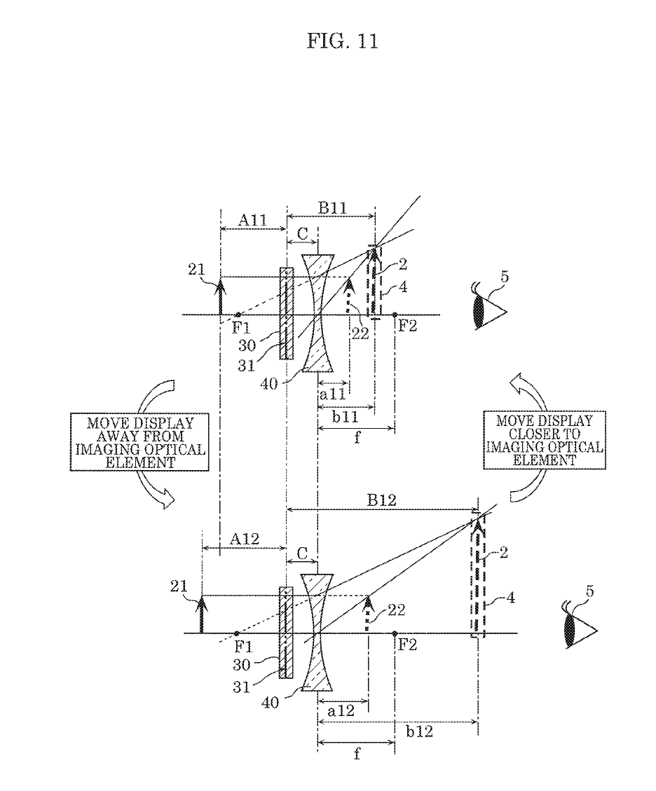

In this embodiment, adjuster 80: enlarges display region 3 and moves display region 3 to a position farther from imaging optical element 30, by increasing the distance between imaging optical element 30 and provisional region 22; or reduces display region 3 and moves display region 3 to a position closer to imaging optical element 30, by decreasing the distance between imaging optical element 30 and provisional region 22. This will be described in detail later, with reference to FIGS. 11 to 13.

In this embodiment, adjuster 80 may perform the adjustment with reference to a table stored in storage 85. As an example, adjuster 80 determines an adjustment mode corresponding to face 6 detected by camera 70 with reference to property table 86 stored in storage 85, and performs the adjustment in the determined adjustment mode. As another example, adjuster 80 determines an adjustment mode corresponding to action detected by camera 70 with reference to action table 87 stored in storage 85, and performs the adjustment in the determined adjustment mode. Each table will be described in detail later.

Adjuster 80 is implemented by, for example, nonvolatile memory storing an adjustment program, volatile memory which is a temporary storage region for executing the adjustment program, an input-output port, and a processor that executes the adjustment program.

### [Storage]

Storage 85 is memory for storing property table 86 and action table 87.

For example, storage 85 is nonvolatile memory such as flash memory.

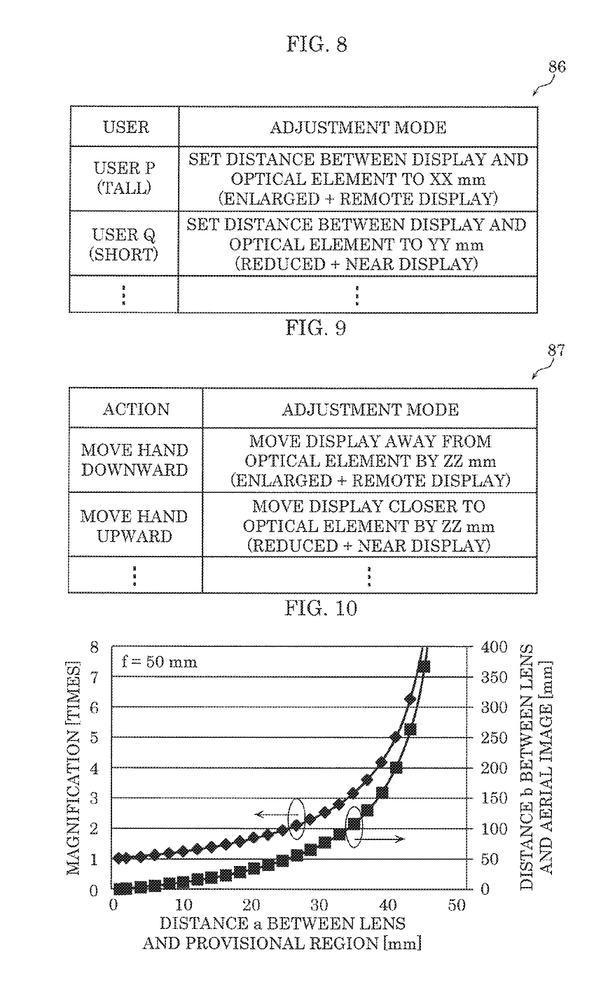

FIG. 8 is a diagram illustrating property table 86 associating users 5 and adjustment modes according to this embodiment. Property table 86 is an example of a third table associating one or more sets of user information and one or more adjustment modes with each other. In detail, user information is information indicating the face of the user. Property table 86 is also an example of a first table.

The face of the user is specifically indicated by a face image of the user captured by camera 70 beforehand. Alternatively, data obtained by extracting, from the face image of the user, feature points such as eyes, nose, and mouth and modelling them may be used. The face of the user may be associated with pre-registered height information and the like of the user.

The adjustment mode is specifically represented by an adjustment object and an adjustment amount. The adjustment object is at least one of display surface 21 (display 20), imaging optical element 30, and concave lens 40. The adjustment amount is indicated by the amount of change from the current position or posture of the adjustment object, or the position or posture after the adjustment.

For example, tall user P is associated with a mode of setting the distance between display 20 and imaging optical element 30 to XX mm, as illustrated in FIG. 8. Here, the adjustment amount “XX mm” is set beforehand so that aerial image 2 is displayed at a position easily viewable by user P.

Moreover, short user Q is associated with a mode of setting the distance between display 20 and imaging optical element 30 to YY mm. Here, the adjustment amount “YY mm” is set beforehand so that aerial image 2 is displayed at a position easily viewable by user Q.

For example, for user P who is tall and has a high face position, aerial image 2 is more easily operable if displayed at a position away from concave lens 40 (cover glass 15). Hence, aerial image 2 for user P is enlarged and displayed at a remote position, as compared with aerial image 2 for user Q who is short and has a low face position. This will be described in detail later.

FIG. 9 is a diagram illustrating action table 87 associating actions of user 5 and adjustment modes according to this embodiment. Action table 87 is an example of a second table associating one or more actions by user 5 and one or more adjustment modes with each other.

An action by user 5 is specifically a gesture performed using the hand(s), face, or whole body of user 5. Examples of the gesture include an action of user 5 moving his or her hand downward, an action of user 5 moving his or her hand upward, and an action of user 5 shaking his or her head horizontally.

In the example illustrated in FIG. 9, the action of moving the hand downward is associated with a mode of moving display 20 away from imaging optical element 30 by ZZ mm. Moreover, the action of moving the hand upward is associated with a mode of moving display 20 closer to imaging optical element 30 by ZZ mm. Thus, aerial image 2 can be enlarged or reduced, or displayed remotely or near, based on the intension of user 5.

In this embodiment, “reduce” means that aerial image 2 is a result of enlarging, at a relatively low magnification, the image displayed on display surface 21. Thus, “reduce” does not mean that aerial image 2 is smaller than the image displayed on display surface 21.

### [Adjustment]

A change of aerial image 2 (display region 3) by adjustment is described below, with reference to FIGS. 10 to 13.

In this embodiment, adjuster 80 changes distance a, by adjusting the position of at least one of display surface 21 (display 20), imaging optical element 30, and concave lens 40. Distance b corresponding to the display position of aerial image 2 and display magnification m can be changed by adjusting distance a, as indicated by (Expression 1) and (Expression 2). In other words, the size and display position of aerial image 2 can be changed based on the adjustment of display surface 21 and the like by adjuster 80.

FIG. 10 is a diagram illustrating the relationship of the display magnification and display position of aerial image 2 with distance a between concave lens 40 and provisional region 22 according to this embodiment. The display position of aerial image 2 is indicated by distance b between concave lens 40 and aerial image 2. FIG. 10 illustrates the case where focal length f of concave lens 40 is 50 mm.

As illustrated in FIG. 10, the display magnification of aerial image 2 increases as distance a between concave lens 40 and provisional region 22 increases. Moreover, distance b between concave lens 40 and aerial image 2 increases as distance a between concave lens 40 and provisional region 22 increases.

The respective cases of adjusting the positions of display surface 21 (display 20), imaging optical element 30, and concave lens 40 are described in order below, with reference to drawings.

### <Movement of Display>

The case of moving only display 20 in a state of fixing imaging optical element 30 and concave lens 40 is described first, with reference to FIG. 11. FIG. 11 is a schematic diagram illustrating a change of aerial image 2 in the case of moving display 20 (display surface 21) in space display apparatus 1 according to this embodiment.

In the case of moving display 20 away from imaging optical element 30 (i.e. in the case where distance A between display 20 and imaging optical element 30 changes from A11 to A12 (>A11)), provisional region 22 also moves to a position away from imaging optical element 30, as illustrated in FIG. 11. This is because provisional region 22 is plane-symmetrical to display surface 21 with respect to element surface 31 of imaging optical element 30. Accordingly, distance a between concave lens 40 and provisional region 22 becomes longer as it changes from a11 to a12 (>a11).

Therefore, distance b between aerial image 2 and concave lens 40 also becomes longer as it changes from b11 to b12 (>b11), as illustrated in FIG. 11. As a result, aerial image 2 is displayed at a position farther from imaging optical element 30. Likewise, the size of aerial image 2 increases when display 20 is moved away from imaging optical element 30.

As described above, by moving display 20 away from imaging optical element 30, aerial image 2 can be enlarged at a higher magnification and displayed more remotely (position at distance B12 from imaging optical element 30). In the case of moving display 20 closer to imaging optical element 30, the opposite to the above applies, so that aerial image 2 can be reduced (enlarged at a low magnification) and displayed at a position closer to provisional region 22 (position at distance B11 from imaging optical element 30).

### <Movement of Imaging Optical Element>

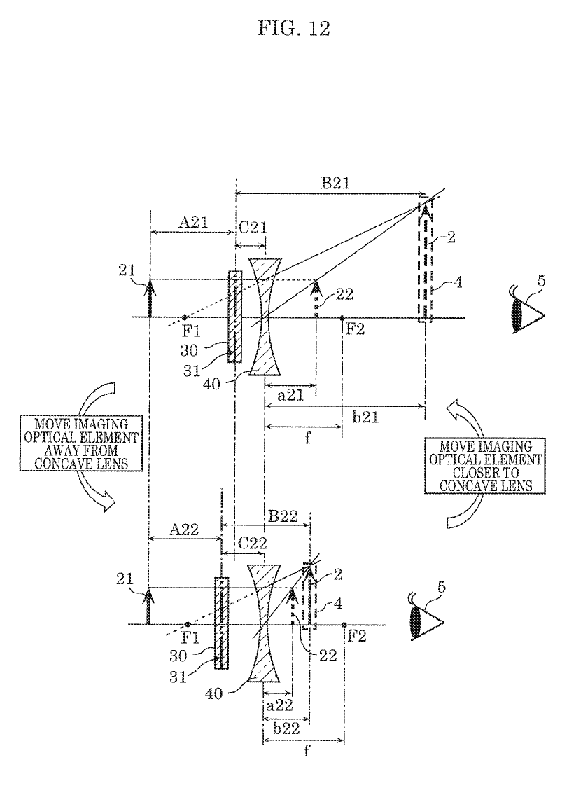

The case of moving only imaging optical element 30 in a state of fixing display 20 and concave lens 40 is described next, with reference to FIG. 12. FIG. 12 is a schematic diagram illustrating a change of aerial image 2 in the case of moving imaging optical element 30 in space display apparatus 1 according to this embodiment.

In the case of moving imaging optical element 30 away from concave lens 40 (i.e. in the case where distance C between imaging optical element 30 and concave lens 40 changes from C21 to C22 (>C21)), distance A between display 20 and imaging optical element 30 changes from A21 to A22 (<A21), as illustrated in FIG. 12.

Accordingly, distance a between concave lens 40 and provisional region 22 becomes shorter as it changes from a21 (=A21−C21) to a22 (=A22−C22<a21), as illustrated in FIG. 12. Therefore, distance b between aerial image 2 and concave lens 40 also becomes shorter as it changes from b21 to b22 (<b21). As a result, aerial image 2 is displayed at a position closer to imaging optical element 30. Likewise, the size of aerial image 2 approaches the size of provisional region 22 when imaging optical element 30 is moved away from concave lens 40.

As described above, by moving imaging optical element 30 away from concave lens 40, aerial image 2 can be reduced and displayed at a position closer to provisional region 22 (position at distance B22 from imaging optical element 30). In the case of moving imaging optical element 30 closer to concave lens 40, the opposite to the above applies, so that aerial image 2 can be enlarged at a high magnification and displayed more remotely (position at distance B21 from imaging optical element 30).

### <Movement of Concave Lens>

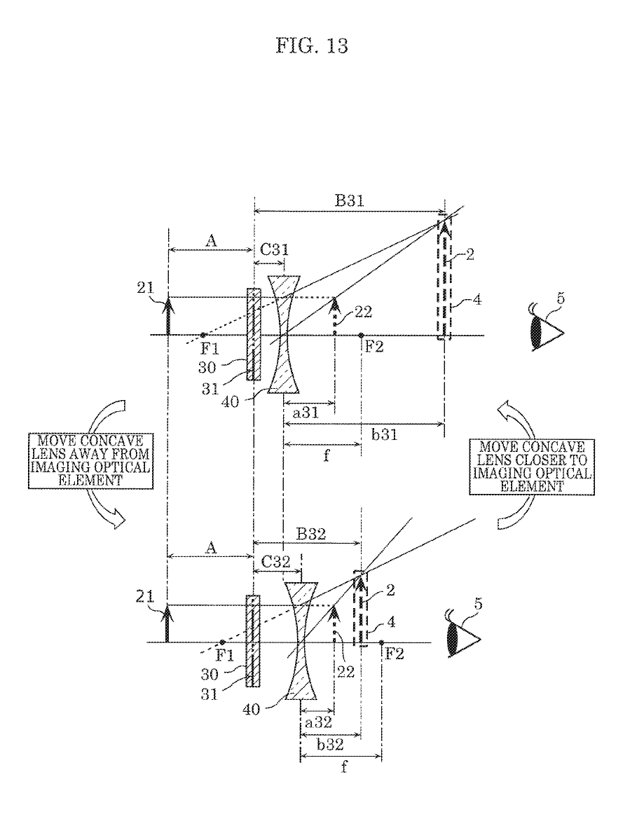

The case of moving only concave lens 40 in a state of fixing display 20 and imaging optical element 30 is described next, with reference to FIG. 13. FIG. 13 is a schematic diagram illustrating a change of aerial image 2 in the case of moving concave lens 40 in space display apparatus 1 according to this embodiment.

In the case of moving concave lens 40 away from imaging optical element 30 (i.e. in the case where distance C between imaging optical element 30 and concave lens 40 changes from C31 to C32 (>C31)), distance a between concave lens 40 and provisional region 22 becomes shorter as it changes from a31 (=A−C31) to a32 (=A−C32<a31), as illustrated in FIG. 13. Therefore, distance b between aerial image 2 and concave lens 40 also becomes shorter as it changes from b31 to b32 (<b31). As a result, aerial image 2 is displayed at a position closer to imaging optical element 30. Likewise, the size of aerial image 2 approaches the size of provisional region 22 when concave lens 40 is moved away from imaging optical element 30.

As described above, by moving concave lens 40 away from imaging optical element 30, aerial image 2 can be reduced and displayed at a position closer to provisional region 22 (position at distance B32 from imaging optical element 30). In the case of moving concave lens 40 closer to imaging optical element 30, the opposite to the above applies, so that aerial image 2 can be enlarged at a high magnification and displayed more remotely (position at distance B31 from imaging optical element 30).

As described above, the position and size of aerial image 2 (display region 3) can be changed by adjuster 80 adjusting the position of display 20 (display surface 21), imaging optical element 30, or concave lens 40. Here, adjuster 80 may adjust not only the position but also the posture (inclination). Alternatively, adjuster 80 may adjust only the posture. For example, by inclining display 20, provisional region 22 is inclined, and aerial image 2 is inclined accordingly. Adjusting the angle of inclination makes it possible to display aerial image 2 at a position easily viewable by user 5. Two or more of display 20 (display surface 21), imaging optical element 30, and concave lens 40 may be moved simultaneously.

In this embodiment, user operation region 4 changes based on the size, position, and posture of aerial image 2, too, as illustrated in FIGS. 11 to 13. For example, in the case where aerial image 2 (display region 3) is enlarged and displayed remotely by moving display 20 away from imaging optical element 30, user operation region 4 is enlarged and changed to be remoter according to aerial image 2, as illustrated in FIG. 11. In the case where aerial image 2 (display region 3) is reduced and displayed close to provisional region 22 by moving display 20 closer to imaging optical element 30, user operation region 4 is reduced and changed to be nearer according to aerial image 2, as illustrated in FIG. 11.

### Advantageous Effects, Etc.

As described above, space display apparatus 1 according to this embodiment is a space display apparatus that forms an image in aerial display region 3 and displays the image as aerial image 2, the space display apparatus including: display 20 that displays the image on display surface 21; concave lens 40; and imaging optical element 30 that includes element surface 31, is located between display surface 21 and concave lens 40, and, in the case of assuming that concave lens 40 is not present, forms the image displayed on display surface 21, in provisional region 22 that is plane-symmetrical to display surface 21 with respect to element surface 31, wherein concave lens 40 is located at a position where distance a from concave lens 40 to provisional region 22 is shorter than focal length f of concave lens 40.

With this structure, the image displayed on display surface 21 is enlarged by imaging optical element 30 and concave lens 40 and displayed remotely. Since enlarged display or remote display of the image displayed on display surface 21 is possible, display surface 21 (display 20) and imaging optical element 30 can be reduced in size. Thus, space display apparatus 1 according to this embodiment is capable of enlarged display or remote display, and can be made compact.

For example, space display apparatus 1 further includes: adjuster 80 that performs adjustment on at least one of a position and a posture of at least one of display surface 21, imaging optical element 30, and concave lens 40.

With this structure, at least one of the position and posture of at least one of display surface 21, imaging optical element 30, and concave lens 40 is variable, so that the position, size, or posture (orientation) of aerial image 2 can be changed.

For example, space display apparatus 1 further includes: camera 70 that detects user 5, wherein adjuster 80 performs the adjustment, according to user 5 detected by camera 70.

With this structure, the position, size, or posture of aerial image 2 can be changed according to detected user 5. For example, aerial image 2 can be made more easily viewable and operable by user 5.

For example, camera 70 detects face 6 of user 5, and adjuster 80 performs the adjustment, based on a position of face 6 detected by camera 70.

With this structure, the position, size, or posture of aerial image 2 can be changed according to the position of detected face 6 of user 5. For example, aerial image 2 can be made more easily viewable and operable by user 5.

For example, space display apparatus 1 may further include: storage 85 that stores property table 86 associating one or more user faces and one or more adjustment modes with each other, wherein adjuster 80 determines, with reference to property table 86, an adjustment mode corresponding to face 6 detected by camera 70, and performs the adjustment in the determined adjustment mode.

With this structure, for example, each user can be associated with an appropriate position, size, or posture of aerial image 2 beforehand. Hence, appropriate aerial image 2 can be displayed according to the detected user.

For example, adjuster 80: performs the adjustment to locate display region 3 at a first position, in the case where a distance between face 6 of user 5 and imaging optical element 30 is greater than a predetermined distance; and performs the adjustment to locate display region 3 at a second position that is closer to imaging optical element 30 than the first position, in the case where the distance between face 6 of user 5 and imaging optical element 30 is less than the predetermined distance.

With this structure, in the case where face 6 of user 5 is close, aerial image 2 can be displayed at a remoter position than the display position of aerial image 2 in the case where face 6 is remote. For example, the distance between face 6 and aerial image 2 can be made approximately constant according to the position of face 6.

For example, space display apparatus 1 may further include: storage 85 that stores action table 87 associating one or more user actions by user 5 and one or more adjustment modes with each other, wherein camera 70 detects an action of user 5, and adjuster 80 determines, with reference to action table 87, an adjustment mode corresponding to the action detected by camera 70, and performs the adjustment in the determined adjustment mode.

With this structure, the position, size, posture, or the like of aerial image 2 can be changed according to an action of user 5. Thus, the display mode of aerial image 2 can be changed in response to demand from user 5.

For example, adjuster 80: enlarges display region 3 and/or moves display region 3 to a position farther from imaging optical element 30, by increasing a distance between imaging optical element 30 and provisional region 22, or reduces display region 3 and/or moves display region 3 to a position closer to imaging optical element 30, by decreasing the distance between imaging optical element 30 and provisional region 22.

With this structure, the size and/or display position of aerial image 2 can be changed merely by changing the distance between imaging optical element 30 and provisional region 22. For example, a simple structure of providing a drive mechanism (element drive 52, etc.) for varying the position of imaging optical element 30 enables enlarged display and/or remote display of aerial image 2.

For example, when aerial image 2 is enlarged in the case of moving at least one of display 20, imaging optical element 30, and concave lens 40, display controller 65 may reduce the image displayed by display 20, according to the movement of each structural member. For example, in the case of moving display 20 away from imaging optical element 30, the image displayed by display 20 may be reduced. In other words, the image may be displayed only in part of display surface 21 of display 20. With this structure, for example, it is possible to change only the display position while maintaining aerial image 2 at a fixed size.

For example, space display apparatus 1 further includes: motion sensor 60 that detects an operation of user 5 on aerial image 2 in user operation region 4 set according to a position of display region 3, wherein, in the case where at least one of a size, a position, and a posture of display region 3 changes as a result of the adjustment performed by adjuster 80, motion sensor 60 adjusts a size, a position, and a posture of user operation region 4 according to display region 3 after the change.

With this structure, since user operation region 4 is also changed in the case where display region 3 is changed, user 5 can operate a GUI or the like included in aerial image 2 by moving his or her finger according to aerial image 2 displayed in display region 3. This enhances user-friendliness.

### Other Variations

Although the space display apparatus according to the present invention has been described above based on the embodiment, the present invention is not limited to the foregoing embodiment.

For example, concave lens 40 may be attached to opening 11 of housing 10, instead of cover glass 15. Moreover, for example, space display apparatus 1 may not include housing 10, and may not be unitized. For example, display 20, imaging optical element 30, and concave lens 40 may be arranged so as to satisfy the above-mentioned positional relationship.

Adjuster 80 may determine the adjustment mode based on not only the height of face 6 of user 5 such as whether user 5 is tall or short, but also the position at which user 5 is standing (e.g. the horizontal position of face 6). For example, in FIG. 1, in the case where user 5 is standing in front of sink 93, aerial image 2 may be inclined to the sink 93 side. In the case where user 5 is standing in front of cooking heater 94, aerial image 2 may be inclined to the cooking heater 94 side. With this structure, aerial image 2 can be displayed at a posture easily viewable by user 5 who is cooking or washing dishes.

For example, space display apparatus 1 may not include a detector that detects a user, such as camera 70. In detail, adjuster 80 may determine an adjustment mode corresponding to user information selected by user 5 with reference to property table 86 stored in storage 85, and perform adjustment based on the determined adjustment mode.

For example, display 20 displays a selection screen of users stored in property table 86, on display surface 21. The selection screen of users includes, for example, the user name or icon image of each of one or more users indicated in property table 86. With this structure, the selection screen of users is displayed as aerial image 2, and so user 5 performs an action of touching a user name or an icon image displayed on the selection screen with his or her finger. Motion sensor 60 detects the movement of the finger of user 5, and adjuster 80 adjusts the position and posture of concave lens 40 or the like based on the selected user.

Thus, space display apparatus 1 may receive a selection operation from user 5, instead of detecting user 5. In this way, even in the case where user 5 cannot be detected successfully, space display apparatus 1 can display aerial image 2 at a position and posture suitable for user 5.

Here, instead of display 20 displaying the selection screen, a plurality of switches 62 may be associated with users 5. When user 5 selects switch 62, space display apparatus 1 adjusts the position and posture of concave lens 40 or the like based on the user associated with selected switch 62.

For example, space display apparatus 1 may not include adjuster 80. In other words, at least one of the position and posture of at least one of display 20, imaging optical element 30, and concave lens 40 may be adjustable not automatically but manually. Alternatively, at least one of the position and posture of at least one of display 20, imaging optical element 30, and concave lens 40 may be fixed so as to be not adjustable.

For example, space display apparatus 1 may include, as an image display, a projector that projects an image on the display surface, instead of display 20. The projector may, for example, project an image on the inner surface (e.g. lower surface) of housing 10, thus displaying the image using the inner surface of housing 10 as the display surface.

For example, space display apparatus 1 may include an infrared sensor as a detector, instead of camera 70. The infrared sensor detects, for example, the position of face 6 of user 5. The infrared sensor as the detector may also serve as motion sensor 60.

The present invention can be realized not only as a space display apparatus, but also as a program including, as steps, processes performed by each structural element in the space display apparatus, or a computer-readable non-transitory recording medium storing the program.

These general and specific aspects may be implemented using a system, an apparatus, an integrated circuit, a computer program, or a computer-readable recording medium, or any combination of systems, apparatuses, integrated circuits, computer programs, or recording media.

Other modifications obtained by applying various changes conceivable by a person skilled in the art to each embodiment and any combinations of the structural elements and functions in each embodiment without departing from the scope of the present invention are also included in the present invention.

### REFERENCE MARKS IN THE DRAWINGS

1 space display apparatus
2 aerial image
3 display region
4 user operation region
user
6 face
display (image display)
21 display surface
22 provisional region
imaging optical element
31 element surface
concave lens
60 motion sensor (operation detector)
70 camera (detector)
80 adjuster
85 storage
86 property table (first table)
87 action table (second table)

1. A space display apparatus that forms an image in an aerial display region and displays the image as an aerial image, the space display apparatus comprising:
an image display that displays the image on a display surface;
a concave lens; and
an imaging optical element that includes an element surface, is located between the display surface and the concave lens, and, in the case of assuming that the concave lens is not present, forms the image displayed on the display surface, in a provisional region that is plane-symmetrical to the display surface with respect to the element surface,
wherein the concave lens is located at a position where a distance from the concave lens to the provisional region is shorter than a focal length of the concave lens.

2. The space display apparatus according to claim 1, further comprising:
an adjuster that performs adjustment on at least one of a position and a posture of at least one of the display surface, the imaging optical element, and the concave lens.

3. The space display apparatus according to claim 2, further comprising:
a detector that detects a user,
wherein the adjuster performs the adjustment, according to the user detected by the detector.

4. The space display apparatus according to claim 3,
wherein the detector detects a face of the user, and
the adjuster performs the adjustment, based on a position of the face detected by the detector.

5. The space display apparatus according to claim 4, further comprising:
a storage that stores a first table associating one or more user faces and one or more adjustment modes with each other,
wherein the adjuster determines, with reference to the first table, an adjustment mode corresponding to the face detected by the detector, and performs the adjustment in the determined adjustment mode.

6. The space display apparatus according to claim 4,
wherein the adjuster:
performs the adjustment to locate the display region at a first position, in the case where a distance between the face of the user and the imaging optical element is greater than a predetermined distance; and
performs the adjustment to locate the display region at a second position that is closer to the imaging optical element than the first position, in the case where the distance between the face of the user and the imaging optical element is less than the predetermined distance.

7. The space display apparatus according to claim 3, further comprising:
a storage that stores a second table associating one or more user actions and one or more adjustment modes with each other,
wherein the detector detects an action of the user, and
the adjuster determines, with reference to the second table, an adjustment mode corresponding to the action detected by the detector, and performs the adjustment in the determined adjustment mode.

8. The space display apparatus according to claim 2, further comprising:
a storage that stores a third table associating one or more sets of user information and one or more adjustment modes with each other,
wherein the adjuster determines, with reference to the third table, an adjustment mode corresponding to user information selected by a user, and performs the adjustment in the determined adjustment mode.

9. The space display apparatus according to claim 2,
wherein the adjuster:
enlarges the display region and/or moves the display region to a position farther from the imaging optical element, by increasing a distance between the imaging optical element and the provisional region, or
reduces the display region and/or moves the display region to a position closer to the imaging optical element, by decreasing the distance between the imaging optical element and the provisional region.

10. The space display apparatus according to claim 2, further comprising:
an operation detector that detects an operation of a user on the aerial image in a user operation region set according to a position of the display region,
wherein, in the case where at least one of a size, a position, and a posture of the display region changes as a result of the adjustment performed by the adjuster, the operation detector adjusts a size, a position, and a posture of the user operation region according to the display region after the change.
